(19) United States
(12) Patent Application Publication
(10) Pub. No.: US 2025/0058742 A1
(43) Pub. Date: Feb. 20, 2025

(54) Apparatus and Method for Actuating a Function of a Motor Vehicle and Motor Vehicle

(71) Applicant: Bayerische Motoren Werke Aktiengesellschaft, Muenchen (DE)

(72) Inventors: Christian BUCHNER, Poing (DE); Kai HOESL, Iffeldorf (DE)

(21) Appl. No.: 18/774,113

(22) Filed: Jul. 16, 2024

(30) Foreign Application Priority Data
Aug. 17, 2023 (DE) 10 2023 122 093.4

(51) Int. Cl. B60R 25/24; B60R 25/20

(52) U.S. Cl. CPC B60R 25/241; B60R 25/209; B60R 2325/20

(57) ABSTRACT

An apparatus for actuating a function of a motor vehicle includes a first transmission/reception device arranged at a first location of the motor vehicle and configured to receive a functional signal for actuating a function of the motor vehicle from a functional device different from the motor vehicle. The apparatus also includes a control device in communication with the first transmission/reception device and configured to determine a communication loss of the first transmission/reception device and to actuate or disable the function based on the determination.

### CROSS REFERENCE TO RELATED APPLICATION

This application claims priority under 35 U.S.C. § 119 from German Patent Application No. DE 10 2023 122 093.4, filed Aug. 17, 2023, the entire disclosure of which is herein expressly incorporated by reference.

### BACKGROUND AND SUMMARY

Apparatus and method for actuating a function of a motor vehicle and motor vehicle

The invention relates to an apparatus and a method for actuating a function of a motor vehicle and to a motor vehicle having an apparatus of this type.

Currently, it is possible to access functions of motor vehicles from outside via one or more transmission/reception devices that communicate with a functional device. However, these transmission/reception devices can be manipulated.

It is thus necessary to be protected against an improper artificial extension of the radio range (so-called relay attacks), such that a request signal of the motor vehicle is prevented from being transmitted beyond the original radio range of the motor vehicle to the functional device outside of the vehicle in order to cause the functional device to transmit its response signal without the user's knowledge.

Possible protection against an artificial range extension is known, for example, from DE 199 27 253 A1. Accordingly, an authentication unit is equipped with an additional motion sensor and, upon receiving the request signal from a motor vehicle, it is checked whether the authentication unit has been in motion during a predetermined time interval prior thereto. This solution assumes that a user performs stepping movements when approaching a motor vehicle, which can be detected by the motion sensor and used to verify the plausibility of the activation process. If, on the other hand, the authentication unit is unused, for example in a residential building, it is inoperative and, even in the event that a request signal from a motor vehicle is forwarded to the authentication unit, then a response signal is prevented from being generated by the authentication unit, and so an activation process fails.

The object of the invention is to specify an improved apparatus and an improved method for actuating a function of a motor vehicle.

This object is achieved according to the invention by the subject of the independent patent claims. Advantageous embodiments of the invention are the subject of the dependent patent claims and the description.

An apparatus according to the invention for actuating a function of a motor vehicle comprises a first transmission/reception device which is arranged at a first location of the motor vehicle and designed to receive a functional signal for actuating a function of the motor vehicle from a functional device different from the motor vehicle and a control device which is in communication with the first transmission/reception device and designed to determine a communication loss of the first transmission/reception device and to actuate or disable the function based on the determination.

The apparatus is used, in particular, to identify a manipulation of one or more transmission/reception devices and thus prevent unauthorized access to functions of the motor vehicle.

For this purpose, the apparatus initially comprises a first transmission/reception device which is arranged at a first location of the motor vehicle.

A transmission/reception device may also be referred to as a transceiver, antenna or armature and is a device of the motor vehicle used to transmit and receive signals. In particular, the transmission/reception device is designed to receive signals wirelessly.

The first transmission/reception device is arranged in this case at a first location of the motor vehicle, in particular at or near a body part, such as in or on a fender, in or on a skirt, in or on a roof element, such as a roof liner, and/or in or on an A, B and/or C pillar. In particular, provision is made of more than one such transmission/reception device which are similar or identical in design, for example at least four, six, eight or ten such transmission/reception devices, each at different locations of the motor vehicle.

The transmission/reception device is designed in this case to receive a functional signal for actuating a function of the motor vehicle from a functional device different from the motor vehicle.

A functional device is in this case an independent object, different from the motor vehicle and spatially separable therefrom, and is used to trigger, perform or effect functions by way of a user of the motor vehicle, without the functional device itself having to be present in the motor vehicle. To this end, the functional device may be arranged at a distance from the motor vehicle for operation, for example 1 m, 2 m, 5 m or 10 m.

To this end, the functional device is designed to communicate, in particular wirelessly, with the motor vehicle or the transmission/reception devices. In particular, the functional device uses ultra-wideband technology (UWB) for this purpose. In particular, the functional signal comprises a characteristic pulse signal from which the desired function can be derived. In addition, the functional device can also support or use another radio technology using which the communication via UWB is prepared and/or initiated.

The functional device may be designed, in particular, as a proprietary piece of equipment, such as a key, transponder and/or fob, and provide one or more functions of the motor vehicle via dedicated keys or pushbuttons.

As an alternative or in addition, the functional device may also be designed as a mobile radio device, in particular as a smartphone, phablet, tablet and/or wearable, which also provides functions of the motor vehicle by means of one or more applications.

The apparatus also comprises a control device which is in communication with the first transmission/reception device.

The control device is used to control, trigger and/or effect one or more functions of the motor vehicle, in particular also—but not exclusively—those that can be actuated by the functional device. The control device may in this case also be referred to as a control unit, in particular also as a central control unit.

The control device is in this case, in particular, connected to all transmission/reception devices, in particular in a wired manner, for example via a bus, such as a CAN bus, and is designed to communicate with these devices and, in particular, to obtain information therefrom.

The control device is in this case designed to determine a communication loss of the first transmission/reception device and to actuate or disable the function based on the determination.

A communication loss in this case comprises an also only temporary loss of communication possibility with or an ability to reach the first transmission/reception device. This may be determined, for example, by no response to a request by the control device, by reception of a shutdown signal from the transmission/reception device or by reception of a reset signal from the transmission/reception device.

In particular, the communication loss is caused by a temporary disconnection of a wired connection between the transmission/reception device and the control device or the bus, via which a power supply for the transmission/reception device is also provided.

It is therefore additionally or alternatively determined whether the transmission/reception device temporarily had no power supply and therefore was shut down and then restarted.

In this case, in particular, it is not an overall power or communication loss that is involved but instead an isolated loss which has affected only the one first transmission/reception device.

If this has been determined by the control device, actuation of the function is disabled or not performed. In particular, in response to the determination of a communication loss, the affected transmission/reception device is disabled, in particular for a predetermined period of time during which functional signals that are received from the transmission/reception device are not processed.

In contrast, if no communication loss has been determined, the control device is designed to actuate, trigger or effect the function.

To this end, the control device may, in particular, receive information regarding the desired function from the first transmission/reception device and/or from the second transmission/reception device.

Further transmission/reception devices which were not affected by a communication loss may, however, continue to be used to receive functional signals and likewise effect performance of the function.

The apparatus according to the invention makes it possible to identify manipulation, in particular a temporary separation of the first transmission/reception device from the motor vehicle, and to carry out suitable defensive measures.

This makes it possible to prevent unauthorized access to vehicle functions.

According to one development, the function comprises unlocking of the motor vehicle.

Unlocking may include one or more of the doors and all the doors of the motor vehicle. In addition or as an alternative, unlocking may include the trunk, in particular in connection with an automatic opening device that opens the trunk lid.

The unlocking may in this case be effected, in particular, by pressing a pushbutton on a key, transponder and/or fob and/or a button on a mobile radio device.

In particular, the unlocking may also take place contactlessly, that is to say without actual actuation of a pushbutton by a user, but purely by approaching the functional device. This type of function may also be referred to as keyless entry or convenient entry.

This development makes it possible to prevent unauthorized access to the interior particularly well.

According to one development, the function comprises ignition of the motor vehicle.

Ignition includes, in particular, the starting of an engine, in particular an internal combustion engine and/or an electric motor, and may also be referred to as providing, activating or initiating an engine function, according to which the motor vehicle can be moved or driven directly, for example by actuation of a gas pedal.

The ignition may in this case be carried out, for example, by actuating a pushbutton or button on the functional device and enable a so-called remote start, for example, to air-condition the vehicle, in particular to heat or cool the vehicle.

The ignition may also be achieved by actuation of a pushbutton or button in the motor vehicle which is not effected by an interaction with the functional device. In this case, however, the propagation time between the functional device and the first transmission/reception device and the propagation time between the functional device and the second transmission/reception device is measured and these are compared with one another in order to initiate this when a threshold value is undershot and to prevent this when the threshold value is exceeded.

This development makes it possible to prevent an unauthorized engine start particularly well.

According to one development, the control apparatus is designed to determine a time period which has elapsed since the communication loss and to actuate or to disable the function based on the determination of the elapsed period of time.

After an, in particular predetermined, period of time has passed, even though a communication loss has been previously determined, the functional signals from the functional device can thus be taken into account again by the first, previously disabled transmission/reception device.

In other words, the disabling of the transmission/reception device can be enabled again after the period of time has passed.

The period of time may in this case be, for example, at least 5 min, 10 min, 30 min, 60 min or 120 min.

This development makes it possible to take into account a communication loss caused by repair or maintenance of the transmission/reception device and to start the transmission/reception device functioning again after the period of time has passed.

In this case, both for unlocking and ignition, a separate elapsed period of time can be determined from when this function is made possible or enabled again and can thus be taken as a basis for a two-stage check.

In particular, a shorter period of time can be set for unlocking than for ignition. For example, a period of time that is 10%, 20%, 50% or 100% greater than a period of time for unlocking can be used as a basis for ignition.

According to one development, the control apparatus is also designed to cancel a disabled function based on a functional signal being received at a second transmission/reception device.

In particular, a function and/or a transmission reception device, in particular the first transmission reception device, was previously disabled since a communication loss was determined. If a functional signal is then received at the second transmission/reception device, the disabling can be canceled again as a result.

It is thus made possible to re-enable or to verify a disabled function and/or a disabled transmission/reception device by way of retrospective verification using a further transmission/reception device.

A method according to the invention for actuating a function of a motor vehicle in this case comprises the steps of receiving a functional signal for actuating a function of the motor vehicle at a first transmission/reception device which is arranged at a first location of the motor vehicle from a functional device different from the motor vehicle, and determining a communication loss of the first transmission/reception device and, based on the determination, actuating or disabling the function by way of a control device which is in communication with the first transmission/reception device.

The method can be carried out, in particular, by an embodiment of an apparatus described above.

A motor vehicle according to the invention comprises an apparatus according to one of the embodiments described above.

With regard to the embodiments of the method and of the motor vehicle as well as the advantages thereof, reference is made to the previously described embodiments of the apparatus and the advantages thereof.

Further features of the invention emerge from the claims, the figures and the description of the figures. The features and feature combinations mentioned above in the description, and the features and feature combinations mentioned below in the description of the figures and/or shown in the FIGURES alone, may be used not only in the respectively specified combination but also in other combinations or individually.

The invention will now be discussed in more detail on the basis of a preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 shows a schematic plan view of an embodiment of an apparatus and a method for actuating a function of a motor vehicle.

### DETAILED DESCRIPTION OF THE DRAWING

In the FIGURES, the same reference signs denote the same or similar functions.

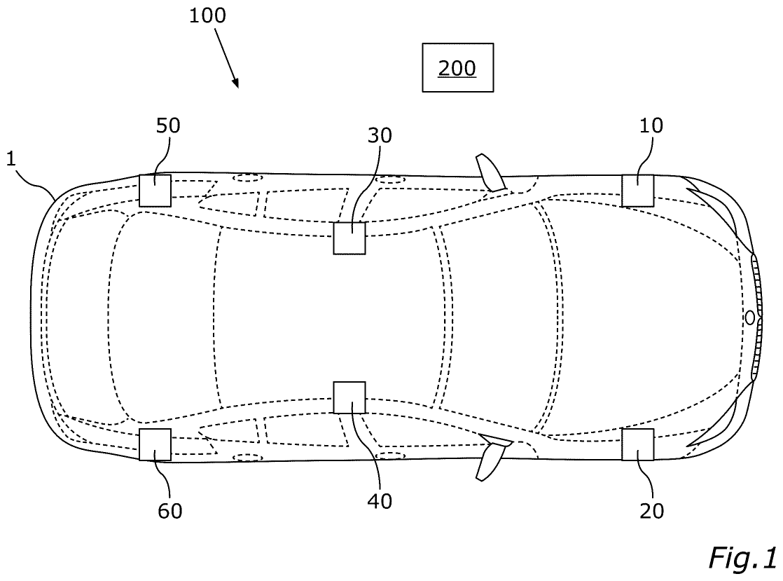

FIG. 1 shows a schematic plan view of an apparatus 100 and a method for actuating a function of a motor vehicle 1.

The apparatus 100 is in this case comprised by the motor vehicle 1 and is designed to perform or effect the method described in the following text.

The apparatus 100 in this case initially comprises a total of six transmission/reception devices 10, 20, 30, 40, 50 and 60 shown by way of example. In this case, a first transmission/reception device 10 is arranged on the left front fender, a second transmission/reception device 20 is arranged on the right front fender, a third transmission/reception device 30 is arranged at a left central position in the roof liner, a fourth transmission/reception device 40 is arranged at a right central position in the roof liner, a fifth transmission/reception device 50 is arranged on the left rear fender and a sixth transmission/reception device 60 is arranged on the right rear fender.

The transmission/reception devices 10, 20, 30, 40, 50, 60 are designed in this case to receive a functional signal for actuating a function of the motor vehicle 1 from a functional device 200 different from the motor vehicle 1 and located at a distance therefrom.

The apparatus 100 also comprises a control device 90 which is in communication with the transmission/reception devices 10, 20, 30, 40, 50, 60 and designed to determine a communication loss of the respective transmission/reception device 10, 20, 30, 40, 50, 60 and to actuate or disable the function based on the determination.

The control apparatus 90 is also designed to determine a time period which has elapsed since the communication loss and to actuate or to disable the function based on the determination of the elapsed period of time.

The control apparatus 90 is also designed to cancel a disabled function based on a functional signal being received at the second transmission/reception device 20.

The function in this case comprises both unlocking of the motor vehicle 1 and ignition of the motor vehicle 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Motor vehicle
10 First transmission/reception device
20 Second transmission/reception device
30 Third transmission/reception device
40 Fourth transmission/reception device
50 Fifth transmission/reception device
60 Sixth transmission/reception device
90 Control device
100 Apparatus
200 Functional device

What is claimed is:

1. An apparatus for actuating a function of a motor vehicle, comprising:
a first transmission/reception device arranged at a first location of the motor vehicle and configured to receive a functional signal for actuating a function of the motor vehicle from a functional device different from the motor vehicle; and
a control device in communication with the first transmission/reception device and configured to:
determine a communication loss of the first transmission/reception device, and
actuate or disable the function based on the determination.

2. The apparatus of claim 1, wherein the function comprises unlocking of the motor vehicle.

3. The apparatus of claim 1, wherein the function comprises ignition of the motor vehicle.

4. The apparatus of claim 1, wherein the control device is configured to determine a time period which has elapsed since the communication loss and to actuate or disable the function based on the determination.

5. The apparatus of claim 1, wherein the control device is configured to cancel a disabled function based on a functional signal being received at a second transmission/reception device.

6. A method for actuating a function of a motor vehicle, comprising:
receiving a functional signal for actuating a function of the motor vehicle at a first transmission/reception device arranged at a first location of the motor vehicle and from a functional device different from the motor vehicle;
determining a communication loss of the first transmission/reception device; and
based on the determination, actuating or disabling the function by way of a control device in communication with the first transmission/reception device.

7. The method of claim 6, wherein the function comprises unlocking of the motor vehicle.

8. The method of claim 6, wherein the function comprises ignition of the motor vehicle.

9. The method of claim 6, further comprising:
determining a time period which has elapsed since the communication loss; and
based on the determination, actuating or disabling the function, by way of the control device.

10. A motor vehicle comprising the apparatus of claim 1.
